(19) United States
(12) Patent Application Publication
(10) Pub. No.: US 2011/0064851 A1
(43) Pub. Date: Mar. 17, 2011

(54) METHOD OF PRODUCING FERMENTED TEA DRINK RICH IN THEAFLAVINS

(76) Inventor: Masumi Takemoto, Shizuoka (JP)

(21) Appl. No.: 12/934,693

(22) PCT Filed: Mar. 27, 2009
(86) PCT No.: PCT/JP2009/001391

§ 371 Date: Nov. 23, 2010

(30) Foreign Application Priority Data
Mar. 28, 2008 (JP) 2008087491

(51) Int. Cl. A23F 3/16; A23F 3/00

(52) U.S. Cl. 426/52; 426/597

(57) ABSTRACT

The present invention provides a convenient and economical process for preparing a fermented tea drink that exhibits little bitterness and astringency and that has an excellent aroma and sweetness. The fermented tea drink can be obtained by adding water to fresh tea leaves and milling for 1 second to 3 minutes with a mixer; incubating the mixture with standing for at least 15 minutes or with stirring semi-anaerobically; removing solid fraction from the mixture; and heating the liquid. The process of the present invention can efficiently convert catechins into theaflavin and can thereby provide a fermented tea drink with a high content of theaflavin, theasinensins A and B, and gallic acid.

### RELATED APPLICATION

This application claims priority based on Japanese Patent Application No. 2008-087491 filed 28 Mar. 2008, the contents of which are hereby incorporated by reference.

### TECHNICAL FIELD

The present invention relates to a process for preparing a fermented tea drink.

### BACKGROUND ART

Primarily four catechins (epicatechin (EC), epigallocatechin (EGC), epicatechin gallate (ECG), and epigallocatechin gallate (EGCG)) are present in tea leaves, and four theaflavins (theaflavin (TF), theaflavin-3-O-gallate (TF3-G), theaflavin-3′-O-gallate (TF3′-G), and theaflavin-3,3′-di-O-gallate (TFDG)) are produced by the catechin combinations indicated below during the process of producing black tea, i.e., during the fermentation process.

EC+EGC→TF

EC+EGCG→TF3-G

ECG+EGC→TF3′-G

ECG+EGCG→TFDG

The following methods are generally used to obtain fermented tea: methods in which the tea leaves are fermented in slurry form; methods in which the tea leaves are ground, a small quantity of water is added, and stirring with shaking is performed. In these methods, the four catechins cited above undergo oxidative polymerization under the effect of the polyphenol oxidase present in the tea leaves, resulting in the production of theaflavin and three types of theaflavin gallate. However, these methods have various drawbacks such as bitterness and astringency, cream down, and a dark red color occur due to the residual EGCG and ECG.

The presence of gallate group contributes in generation of a bitter and astringent taste in fermented tea drinks. For example, the ECG and EGCG in green tea are strongly bitter and astringent, while the EC and EGC are lightly bitter. Similarly, with regard to the four theaflavins, which are catechin polymers, the bitter and astringent taste is also increased when TF3-G, TF3′-G, and TFDG containing gallate group are present in large amounts. In the case of black tea, the presence of EGCG, ECG, TF3G, TF3′-G, and TFDG in black tea may cause cream-down. A higher theaflavin (TF) content is associated with a higher commercial value in the black tea market. In order to solve these problems, a method has been developed where the bitter and astringent taste is reduced through cleavage of the gallate group in EGCG, ECG, TF3G, TF3′G, and TFDG by the addition of tannase during the fermentation step (see, for example, Japanese Patent Application Laid-open No. H11-225672). Another method involves addition of a solution of enzymes such as cellulase, hemicellulase, and protopectinase that disrupt tea leaf tissue in the fermentation process of fresh tea leaves (see, for example, Japanese Patent Application Laid-open No. 2004-113090).

The reference documents cited in the application are as indicated below. The contents of these documents are hereby incorporated by reference in its entirety.

Patent Reference 1: Japanese Patent Application Laid-open No. H11-225672

### Patent Reference 2: Japanese Patent Application Laid-open No. 2004-113090

### DISCLOSURE OF THE INVENTION

An object of the present invention is to provide an inexpensive and convenient process for preparing a fermented tea drink that exhibits little bitterness and astringency and has an excellent aroma and sweetness, as well as a fermented tea concentrate, and a powdered fermented tea concentrate.

The inventor discovered that a black tea-flavored fermented tea drink that exhibits an excellent sweetness and aroma and little bitterness and astringency and that is entirely free of cream down can be produced by adding a large amount of water to fresh, unwithered tea leaves and milling with a mixer, incubating the mixture with stirring semi-anaerobically or with standing, removing a solid fraction from the mixture, and heating the liquid. Thus, the present invention provides a process for preparing a fermented tea drink by adding water to fresh tea leaves and milling, incubating the mixture with standing for at least 15 minutes, removing a solid fraction from the mixture, and heating the liquid to obtain the fermented tea drink. The present invention additionally provides a process for preparing a concentrate by concentrating the liquid after heating.

In the process of the present invention, fresh tea leaves milled in water for 1 second to 3 minutes with a mixer, are allowed to stand for at least 15 minutes, preferably at least 24 hours, and more preferably at least 120 hours. Then the solid fraction is removed and the liquid is heated. Also preferably, the incubation step is carried out with the addition of at least five-fold (w/w) water (weight basis with respect to the fresh tea leaves) and more preferably at least seven-fold water (w/w). According to the present invention, catechins are converted in good yields to theaflavin without addition of enzymes, such as tannase or tea leaf tissue disrupting enzymes, providing a fermented tea drink that has a high content of theaflavin, theasinensins A and B, and gallic acid. Compared to the gallate group-bearing TF3G, TF3′G, and TFDG, theaflavin has less bitterness and astringency and is sweet and has a beautiful bright orange color.

According to the process of the present invention, the four catechins (EC, EGC, ECG, EGCG) in tea leaves that will cause a bitter and astringent taste are almost entirely converted to catechin polymers including theaflavin, theasinensin A, and theasinensin B. As a consequence, the fermented tea drink produced according to the present invention is almost entirely free of the epigallocatechin gallate, epicatechin gallate, epigallocatechin, epicatechin, theaflavin-3-O-gallate, theaflavin-3′-O-gallate, and theaflavin-3,3′-di-O-gallate that are bitterness and astringency components, and thus exhibits little bitterness and astringency and has an enhanced sweetness and aroma and shows excellent storability. In addition, the fermented tea drink does not undergo cream-down. Particularly preferably, the fermented tea drink produced according to the present invention substantially free of epigallocatechin gallate or epicatechin gallate. That is, the total quantity of epigallocatechin gallate and epicatechin gallate in the product is less than 0.1% with reference to the weight of the starting fresh tea leaves, and peaks for these substances are not observed in analysis by ordinary high-performance liquid chromatographic (HPLC), such as those used in the examples below. In experiments at the cellular level, theaflavin has been reported to have much higher platelet aggregation inhibitory activity than EGCG and a higher activity than TF3G, TF3′G, and TFDG. Moreover, a high antioxidation activity, a high antibacterial activity, and a high blood sugar lowering activity have also been reported. Furthermore, the liberated gallic acid is reported to have a high antioxidation activity, a high anti-carcinogenic activity, and a high anti-obesity effect. The theaflavin content of the fermented tea drink of the invention is much higher than the conventional black tea (dried black tea leaves) which contains as low as 0.08% theaflavin. Thus, the fermented tea drink of the present invention is expected to serve as a health drink for the prevention of lifestyle diseases, for example, in individuals with a risk of thrombosis or high blood sugar level.

### PREFERRED EMBODIMENT OF THE INVENTION

The fresh tea leaves used in the process of the present invention refer to tea leaves after harvested but prior to execution of the withering step, and also refer to tea leaves frozen after harvesting but prior to the execution of the withering step. The fresh tea leaves encompass both fresh tea leaves and stems, which may be used separately or in combination. The starting fresh tea leaves may be tea leaves of any of the green tea and black tea cultivars in general cultivation. Examples of typical tea leaves in cultivation in Japan include asatsuyu, yabukita, yamatomidori, makinoharawase, kanayamidori, okumidori, ooiwase, okuhikari, meiryoku, samidori, komakage, yamanami, minekaori, hatsumomiji, benifuuki, benihomare, and benihikari. The present invention is not limited to these cultivars, and tea leaves from any cultivar grown domestically or overseas can also be used. The fresh tea leaves may be used immediately after harvest or may be frozen immediately after harvest and stored before use. The tea leaf harvest can be first flush, second flush, third flush, or fourth flush. The catechin quantities and the activities of the polyphenol oxidase, peroxidase, tannase, and hydrolytic enzymes vary with harvest, and the process conditions are preferably controlled as appropriate depending on the particular quality of tea leaf used. When the cost, catechin quantity, enzymatic activity, and so forth are comprehensively evaluated, second flush teas and third flush teas are desirable for the tea leaf used in the process of the present invention. In the case of fourth flush teas, the catechin quantity and enzymatic activity are fairly inferior, but the enzymes may be activated when the tea leaves are held for several days at room temperature after harvesting, thus yielding a fermented tea with an excellent taste and aroma.

In the process of the present invention, first, water is added to the fresh tea leaves prior to the withering step and the fresh tea leaves and milled in water using, for example, a mixer. Preferably the milling step is carried out after the water is added to the tea leaves. If the water is added after the tea leaves have been milled in air, the components present in the cells of the tea leaves will not transfer well into the aqueous phase and thus the theaflavin content in the product is low. In this case, flavor and aroma as well as ingredients of the drink product are inferior to those obtained by milling in water (Comparative Example 1). The milling step can be carried out at a temperature from 0° C. to 30° C. The milling time is preferably from 1 second to 3 minutes, more preferably is 1 minute. With a short milling time, the fermented tea drink obtained will contain only theaflavin, while at long milling time the fermented tea drink will contain theaflavins, with theaflavin being the main component. When the milling time is shorter than 1 minute, the cells in the tea leaves are not sufficiently disrupted and the fermented tea drink will have a low content of theaflavins. When the milling time exceeds 5 minutes, and the standing time is not sufficiently long, the catechins are not completely converted into theaflavin, and the fermented tea drink will contain much theaflavin gallate form and have a bitter and astringent taste. The mixer as used herein is a household mixer (blender) with a capacity of approximately 700 to 1000 mL and an output power of about 200 to 300 W. When the present invention is scaled up to the industrial production level, those skilled in the art can select a suitable milling time in view of the device used and the quantity to be processed. An example of an industrial production mixer that can be used in the present invention is a commercial mixer (blender) with a capacity of approximately 4000 mL and an output power of about 1400 W, with the revolving speed of high speed (18,500 rpm), medium speed (16,300 rpm), or low speed (14,000 rpm). A custom-made mixer (blender) may be used when even greater scale is desired, or the mixing process may be repeated in conformity to the quantity of tea leaves. No difference in flavor, aroma, or components is observed between the drink prepared by a repetitive process and the drink produced without using a repetitive process. Any device capable of milling can be used to mill the fresh tea leaves, and examples include mixers, ultramixers, hammer mills, homogenizers, and so forth, wherein mixers (blenders) are particularly preferred.

After the milling step, the mixture is stirred semi-anaerobically or is allowed to stand without separating the tea leaves from the liquid. As used herein, semi-anaerobic stirring denotes stirring of the tea leaves and water with avoiding the incorporation of air. This step can be carried out using, for example, a mixer, stirrer, rotating plate, or bottle roller, by operating at a speed that avoids the incorporation of air into the liquid. Degassing and the exclusion of air are not required. Gentle stirring using a stirrer is particularly preferred. When water is added to the fresh tea leaves and milled, components present in the cells of the tea leaves, e.g., polyphenol oxidase, peroxidase, tannase, hydrolytic enzymes, and various tea components such as catechins and caffeine will leach into the water. When the liquid containing these enzymes and components is semi-anaerobically stirred or allowed to stand, the catechins are converted into theaflavins by the action of these enzymes.

Peroxidase is an enzyme that produces theaflavin in the presence of hydrogen peroxide. In the process of the present invention, hydrogen peroxide need not to be added because it is produced metabolically. Polyphenol oxidase is an enzyme that produces theaflavin in the presence of oxygen. Since the supply of oxygen is very limited during incubation with standing, it does not function once the dissolved oxygen in the water has been consumed. Accordingly, comparing the polyphenol oxidase with peroxidase involved in theaflavin production, the polyphenol oxidase exhibits less function when incubation is carried out by standing. Tannase can cleave off the gallate group in catechins and theaflavins. Cleavage of the gallate group also occurs by the action of the hydrolytic enzymes. During incubation by standing, due to the cessation of the oxygen supply, peroxidase is predominantly functional and the catechins are converted to theaflavins (TF, TF3G, TF3′G, TFDG), with the main component being theaflavin. As the mixture is left stand for longer period of time, the hydrolytic enzymes will work with peroxidase and TF3G, TF3′G, and TFDG will be hydrolyzed and entirely converted to TF. Gallic acid is produced by these reactions. In addition, theasinensin A is produced by the dehydrogenation and condensation of two EGCGs through their pyrogallol rings, while theasinensin B is produced by dehydrogenation and condensation between EGCG and EGC through their pyrogallol rings. The same enzymatic reactions will proceed with the semi-anaerobic stirring as in incubation by standing. The stirring must be very gentle and care should be exercised to avoid the incorporation of air.

At longer standing time, the following reactions are also thought to proceed. First, TF is produced from EC and EGC by the enzymatic reaction of peroxidase. On the other hand, the ECG and EGCG are converted to EC and EGC, respectively, by cleavage of the gallate group by tannase or a hydrolytic enzyme, and further converted to TF by peroxidase. The hydrolysis reaction is an equilibrium reaction. Since the EC and EGC generated by hydrolysis are converted to theaflavin by peroxidase, the equilibrium is shifted to the right as EC and EGC are consumed, and ECG and EGCG hydrolysis reactions therefore go forward. By semi-anaerobic stirring, the same enzymatic reactions will proceed as in the long standing incubation. The stirring must be very gentle and care must be exercised to avoid the incorporation of air.

The standing time will vary depending on the type of tea leaf used, the water content, the storage conditions, and so forth, but is preferably at least 15 minutes, more preferably at least 24 hours, even more preferably at least 48 hours, and even more preferably at least 120 hours. There is no particular upper limit on the standing time, and the reactions can be stopped at a suitable time with monitoring production of the theaflavins. The standing temperature should be within the temperature range in which the enzymes can function, for example, but is not limited, from 10° C. to 40° C., preferably from 20° C. to 30° C. When stirring is carried out with a stirrer, all of the catechins will be converted to theaflavin in from 20 minutes to several hours. However, when stirring with a stirrer is continued for a long period of time, the theaflavin will further be converted into, for example, thearubigin, by enzymatic reactions, resulting in a sharp decline in the quantity of theaflavin. The stirring time is preferably not more than 24 hours.

The quantity of water added to the fresh tea leaves can be selected as appropriate depending on the type of tea leaves used, the water content, the storage conditions, and so forth, but is preferably from 5 mL to 500 mL per 1 g fresh tea leaves, more preferably from 7 mL to 200 mL per 1 g fresh tea leaves, and even more preferably from 10 mL to 100 mL per 1 g fresh tea leaves. At less than 5 mL, the quantity of theaflavin production will decline, while at more than 500 mL the resulting fermented tea drink will have little flavor. In addition, a green tea extract may be used in addition to the water or in place of the water. An aqueous solution that contains catechins can be used as the green tea extract, for example, a liquid prepared by the addition of water to heat-processed green tea leaves and extraction; a liquid prepared by the addition of water to heat-processed green tea leaves, extraction, concentration to give a tea extract, and addition of water to the tea extract; and a liquid prepared by the addition of water to a tea extract.

When water was added immediately after harvesting to fresh, second flush leaves of yabukita tea, milled with a mixer for 1 minute, and incubated with standing for 24 hours, the catechins were converted to theaflavins with the production of TF, TF3G, TF3′G, and TFDG. When standing time was 120 hours, the four catechins were all converted to theaflavin, theasinensin A, and theasinensin B. In addition, when water was added immediately after harvesting to fresh, second flush leaves of yabukita tea, milled with a mixer for 3 minutes, and incubated with standing for 24 hours, the catechins were converted to theaflavins with the production of TF, TF3G, TF3′G, and TFDG. When standing time was 120 hours, the four catechins were all converted into theaflavin as the main component, and TF3G, TF3′G, and TFDG and theasinensins A and B. It is believed that an appropriate quantity of the four theaflavins leaches into the water when the milling time is short, which results in the conversion of all the catechins into theaflavin due to the reactions mediated by polyphenol oxidase, peroxidase, tannase, or the hydrolytic enzymes. When, on the other hand, a long milling time is employed, the quantity of the four theaflavins leaching into the water is excessively large, and as a consequence hydrolysis does not proceed to completion even at long standing time. The product contains a large amount of theaflavin, but still contain the gallate forms of theaflavin.

The fermented tea obtained by the process of the present invention has a bright orange color, an enhanced sweetness and aroma, and a mild taste that is almost entirely free of bitterness and astringency. In addition, gallic acid is produced in large amounts due to cleavage of the gallate group in EGCG and ECG. The fermented tea obtained by the process of the present invention also contains functional components theasinensin A and theasinensin B, large amounts of polyphenols and large amounts of gallic acid, which has a very high antioxidation activity, anti-carcinogenic activity, and anti-obesity effect. The polyphenol quantity is determined by the Folin-Denis method with subtracting the amount of catechin.

After standing incubation for a desired period of time, the reaction mixture is filtered to remove the solid fraction. Filtration may be carried out by gravity filtration or by suction filtration under reduced pressure. Alternatively, the solid fraction may be removed by centrifugation. When stirring is carried out using a stirrer, the reaction mixture may be filtered immediately after stirring. An excellent aroma and taste can be obtained when the liquid is placed in a refrigerator immediately after stirring and left for 1 or 2 days. The resulting solution presents an orange or bright red color. The liquid is bottled and heated at from 95° C. to 100° C. for from about 5 to 10 minutes on a hot water bath with an aluminum foil capping for preventing loss of aroma, and then allowed to stand at room temperature to obtain a fermented tea drink. An autoclave treatment may be employed as an alternative. An oxidation inhibitor such as sodium ascorbate may be added as necessary. When the process of the present invention is scaled up to the industrial production level, a crude filtration may be carried out by conventional methods followed by filtration using, for example, a Sharples centrifuge. In the case of producing a canned drink, the product is subjected to retort sterilization according to the requirements of the Food Sanitation Act. In the case of plastic bottles, tube sterilization or plate sterilization by the hot pack filling method may be employed. After the heat treatment, the liquid is subjected to a concentration step, e.g., vacuum concentration, spray drying, freeze drying, and so forth to produce a concentrated liquid or powdered extract. The product can be provided as food products in various forms or as raw materials in various industries, such as food supplements, health care products, confectionary, pharmaceuticals, and food products.

The contents of all of the patents and reference documents explicitly cited in the application are hereby incorporated by reference in its entirety.

### EXAMPLES

The present invention is described in greater detail by the examples provided below, but the present invention is not limited by these examples. The contents of EC, ECG, EGC, EGCG, TF, TF3G, TF3′G, and TFDG were analyzed using an HPLC instrument (JASCO, PU-980, UV-970) and an ODS120A column (TOSOH, 4.6 mm×250 mm). The HPLC conditions were as follows: solvent=acetonitrile:ethyl acetate:0.05% H₃PO₄=21:3:76; flow rate=1.0 mL/min; temperature=25° C. Detection with 280 nm W. The measurements were calculated with respective calibration curves.

### Example 1

### Example of the Use of Five-Fold Water with Respect to the Fresh Tea Leaves and Standing for 120 Hours after Milling for 1 Minute

100 mL distilled water was added to 20 g yabukita tea leaves that had been harvested on 18 July and milled for 1 minute using a household mixer and then transferred to a 100-mL Erlenmeyer flask, which was capped with aluminum foil and held for 120 hours at room temperature. The mixture was filtered by suction filtration and the filtrate was transferred to a glass bottle, which was capped with aluminum foil. This was followed by heating on a hot water bath at 100° C. for 10 minutes and then standing at room temperature. Analysis by HPLC gave 200 mg TF (0.2%) and 282 mg caffeine (0.28%) per 100 g fresh leaves.

### Example 2

### Example of the Use of Ten-Fold Water with Respect to the Fresh Tea Leaves and Standing for 120 Hours after Milling for 1 Minute

100 mL distilled water was added to 9.6 g yabukita tea leaves that had been harvested on 18 July and milled for 1 minute using a household mixer and then transferred to a 100-mL Erlenmeyer flask, which was capped with aluminum foil and held for 120 hours at room temperature. The mixture was filtered by suction filtration and the filtrate was transferred to a glass bottle, which was capped with aluminum foil. This was followed by heating on a hot water bath at 100° C. for 10 minutes and then standing at room temperature. Analysis by HPLC gave 400 mg TF (0.4%) and 440 mg caffeine (0.44%) per 100 g fresh leaves.

### Example 3

### Example of the Use of Eighty-Fold Water with Respect to the Fresh Tea Leaves and Standing for 120 Hours after Milling for 1 Minute

800 mL distilled water was added to 9.6 g yabukita tea leaves harvested on 18 July and milled for 1 minute using a household mixer and then transferred to a 1000-mL Erlenmeyer flask, which was capped with aluminum foil and held for 120 hours at room temperature. The mixture was filtered by suction filtration and the filtrate was transferred to a glass bottle, which was capped with aluminum foil. This was followed by heating on a hot water bath at 100° C. for 10 minutes and then standing at room temperature. Analysis by HPLC gave 780 mg TF (0.78%) and 435 mg caffeine (0.44%) per 100 g fresh leaves.

### Example 4

### Example of the Use of Ten-Fold Water with Respect to the Fresh Tea Leaves and Standing for 120 Hours after Milling for 3 Minutes

100 mL distilled water was added to 10.0 g yabukita tea leaves harvested on 18 July and milled for 3 minutes using a household mixer and then transferred to a 100-mL Erlenmeyer flask, which was capped with aluminum foil and held for 120 hours at room temperature. The mixture was filtered by suction filtration and the filtrate was transferred to a glass bottle, which was capped with aluminum foil. This was followed by heating on a hot water bath at 100° C. for 10 minutes and then standing at room temperature. Analysis by HPLC gave 350 mg TF (0.35%), 25.1 mg TF3G (0.025%), 12.0 mg TF3′G (0.012%), 7.1 mg TFDG (0.007%), and 307 mg caffeine (0.31%) per 100 g fresh leaves.

### Example 5

### Example of the Use of Eighty-Fold Water with Respect to the Fresh Tea Leaves; Standing for 120 Hours after Milling for 3 Minutes

800 mL distilled water was added to 9.70 g yabukita tea leaves harvested on 18 July and milled for 3 minutes using a household mixer and then transferred to a 1000-mL Erlenmeyer flask, which was capped with aluminum foil and held for 120 hours at room temperature. The mixture was filtered by suction filtration and the filtrate was transferred to a glass bottle, which was capped with aluminum foil. This was followed by heating on a hot water bath at 100° C. for 10 minutes and then standing at room temperature. Analysis by HPLC gave 630 mg TF (0.63%), 78.2 mg TF3G (0.078%), 20.0 mg TF3′G (0.020%), 32.1 mg TFDG (0.032%), and 435 mg caffeine (0.44%) per 100 g fresh leaves.

### Example 6

### Example of Scale Up Using Five-Fold Water with Respect to Frozen Fresh Tea Leaves and Stirring with a Stirrer after Milling for 1 Minute

480 g yabukita tea leaves harvested on 25 June were packed in an aluminum vacuum pack and were frozen and stored at −78° C. After 1 week, 4 L water was added to 120 g of the tea leaves that had been stored frozen and milled for 1 minute in an industrial mixer (high speed). The mixture was transferred to a 30-L stainless steel tank. The entire quantity of tea leaves (480 g) was milled by repeating this process for 4 times, and 9 L water was added to bring the total quantity of water to 25 L. The mixture was gently stirred for 40 minutes using an industrial stirrer. After crude filtration, Na ascorbate was added and filtrated, and then subjected to retort sterilization. Analysis by HPLC gave 3.5 g TF (0.35%), 5.0 g gallic acid (0.5%), 7.4 g caffeine (0.74%), and 12.7 g (1.3%) polyphenols (PPh) (Folin-Denis method) per 1 kg of the tea leaves.

### Example 7

### Example of the Use of a Mixture of Water and a Liquid Extract of Heat-Processed Green Tea Leaves in Place of Water

100 g frozen tea leaves (tea leaves harvested on 25 June) were added to a liquid prepared by extracting heat-processed fourth flush tea (50 g) with 2 L water; milled for 1 minute with an industrial mixer (high speed); and gently stirred with the industrial mixer for 40 minutes with keeping unruffled water surface. The mixture was stored for 2 days in a refrigerator, while a mild taste was achieved. After crude filtration, Na ascorbate was added and filtered, and then subjected to retort sterilization. HPLC analysis showed that the 2 liters of the drink contained 1.2 g TF, 1.6 g gallic acid, and 2.6 g caffeine.

### Example 8

### Example of Powdered Concentrate from the Prepared Drink

350 mL water was added to 7.7 g yabukita tea leaves harvested on 18 July and milled for 1 minute using a household mixer and then transferred to a 500-mL Erlenmeyer flask, which was capped with aluminum foil and held for 120 hours at room temperature. The mixture was filtered by suction filtration and the filtrate was transferred to a glass bottle, which was capped with aluminum foil. This was followed by heating on a hot water bath at 100° C. for 10 minutes and then freeze drying to obtain a product of 1.5 g. The product contained as its main components 15 mg TF, 22 mg gallic acid, 37.1 mg caffeine, and 315 mg polyphenols (Folin-Denis method).

### Example 9

### Example of the Use of Stems

300 mL water was added to 20.5 g stems of benifuuki harvested on 15 July; milled for 1 minute with an industrial mixer followed by transfer to a 100-mL Erlenmeyer flask and gentle stirring for 2 hours. After crude filtration, Na ascorbate is added and filtered, then subjected to retort sterilization. 30 mg TF (0.03%) and 96 mg caffeine (0.1%) were obtained per 100 g fresh stems.

### Comparative Example 1

### Comparative Example where the Leaves were Milled in the Air

9.6 g yabukita tea leaves harvested on 18 Jul. 2007 were milled for 1 minute with a mixer. 100 mL distilled water was added and transferred to a 100-mL Erlenmeyer flask, and allowed for stand for 120 hours at room temperature with capping with aluminum foil. The mixture was filtered by suction filtration and the resulting filtrate was transferred to a glass bottle. The liquid was heated at 100° C. on a hot water bath for 10 minutes with aluminum foil capping, and then allowed for stand at room temperature. HPLC analysis gave 150 mg TF (0.15%) and 150 mg caffeine (0.15%) per 100 g fresh leaves.

The tea drinks obtained in the examples and comparative examples were evaluated by 100 panelists for aroma, water color, body, sweetness, and bitterness and astringency.

### Examples 1 and 6

aroma: mild aroma

water color: appropriate orange color

body: slightly weak body

bitterness and astringency: very weak

sweetness: a little weak

Comprehensive evaluation: soothing sensation due to the mild aroma; when held in the mouth, very weak bitterness and astringency, body and sweetness are slightly lacking, but very easily drinkable.

### Examples 2 and 3

aroma: mild aroma

water color: dark orange color

body: appropriate

bitterness and astringency: very weak

sweetness: suitable sweetness

acidity: Almost none of the panelists perceived acidity, but some panelists with excellent palates did hint at a perception of the acidity of the gallic acid. All the panelists evaluated them as a brisk acidity.

Comprehensive evaluation: soothing sensation due to the mild aroma; when held in the mouth, very weak bitterness and astringency, a perception of body and a perception of sweetness are present; a soothing effect can be expected; very good balance as a whole.

### Examples 4 and 5

aroma: mild aroma

water color: dark orange color

body: appropriate

bitterness and astringency: slight bitterness

sweetness: appropriate sweetness acidity: not noted

Comprehensive evaluation: soothing sensation due to the mild aroma; when held in the mouth, very weak bitterness and astringency, a perception of body and a perception of sweetness are present; a soothing effect can be expected; very good balance as a whole.

### Comparative Example 1

aroma: weak aroma

water color: dark orange color

body: appropriate

bitterness and astringency: bitterness is detected

sweetness: weak sweetness

Comprehensive evaluation: weak aroma; when held in the mouth, bitterness and astringency are detected, while almost no sweetness is perceived.

TABLE 1

| | | weight | | | TF | TF3G | TF3′G | TFDG | EGCG | ECG | Caffeine |
|---|---|---|---|---|---|---|---|---|---|---|---|
| No | tea leaf | (g) | water | method | (%) | (%) | (%) | (%) | (%) | (%) | (%) |
| Example | yabukita | 20 | 100 ml | mixer 1 min | 0.2 | 0 | 0 | 0 | 0 | 0 | 0.28 |
| 1 | | | | standing 120 h | | | | | | | |
| Example | yabukita | 9.6 | 100 ml | mixer 1 min | 0.4 | 0 | 0 | 0 | 0 | 0 | 0.44 |
| 2 | | | | standing 120 h | | | | | | | |
| Example | yabukita | 9.6 | 800 ml | mixer 1 min | 0.78 | 0 | 0 | 0 | 0 | 0 | 0.44 |
| 3 | | | | standing 120 h | | | | | | | |
| Example | yabukita | 10.0 | 100 ml | mixer 3 min | 0.35 | 0.025 | 0.012 | 0.007 | 0 | 0 | 0.31 |
| 4 | | | | standing 120 h | | | | | | | |
| Example | yabukita | 9.70 | 800 ml | mixer 3 min | 0.63 | 0.078 | 0.020 | 0.032 | 0 | 0 | 0.44 |
| 5 | | | | standing 120 h | | | | | | | |

TABLE 2

| | | weight | | | TF | GA | Caffeine | PPh |
|---|---|---|---|---|---|---|---|---|
| No | tea | (g) | water | method | (%) | (%) | (%) | (%) |
| Example | yabukita | 480 | 25 L | mixer 1 min | 0.35 | 0.5 | 0.74 | 1.3 |
| 6 | (frozen) | | | stirring 40 min | | | | |
| Example | yabukita | 100 | 2 L | mixer 1 min | 1.2 (g) | 1.6 (g) | 2.6 (g) | — |
| 7 | (frozen) | | (heated tea leaf | stirring 40 min | | | | |
| | | | liquid extract) | standing 48 h | | | | |
| Example | benifuuki | 20.5 | 300 ml | mixer 1 min | 0.03 | — | 0.1 | — |
| 9 | (stems) | | | stirring 2 h | | | | |
| Comparative | yabukita | 9.6 | 100 ml | milling in | 0.15 | — | — | 0.15 |
| Example | | | | air 1 min | | | | |
| 1 | | | | standing 120 h | | | | |

1. A process for preparing a fermented tea drink, comprising the steps of:
adding water to fresh tea leaves and milling the mixture with a mixer;
incubating the mixture with standing for at least 15 minutes or with stirring semi-anaerobically;
removing a solid fraction from the mixture; and
heating the liquid to obtain the fermented tea drink.

2. A process for preparing a fermented tea concentrate, comprising the steps of:
adding water to fresh tea leaves and milling the mixture with a mixer;
incubating the mixture with standing for at least 15 minutes or with stirring semi-anaerobically;
removing a solid fraction from the mixture;
heating the liquid; and
concentrating the liquid.

3. The process according to claim 1, wherein the incubation is carried out by standing for at least 24 hours.

4. The process according to claim 3, wherein the incubation is carried out by standing for at least 120 hours.

5. The process according to claim 1, wherein the incubation is carried out in the presence of at least five-fold (w/w) water with reference to the fresh tea leaves.

6. The process according to claim 5, wherein the incubation is carried out in the presence of at least seven-fold (w/w) water with reference to the fresh tea leaves.

7. The process according to claim 1, wherein a milling time is from 1 second to 3 minutes.

8. The process according to claim 1, wherein stems of tea leaves are used as the fresh tea leaves.

9. A fermented tea drink obtained by the steps of:
adding water to fresh tea leaves and milling the mixture with a mixer;
incubating the mixture with standing for at least 15 minutes or with stirring semi-anaerobically;
removing a solid fraction from the mixture; and
heating the liquid.

10. A fermented tea concentrate obtained by the steps of:
adding water to fresh tea leaves and milling the mixture with a mixer;
incubating the mixture with standing for at least 15 minutes or with stirring semi-anaerobically;
removing a solid fraction from the mixture;
heating the liquid; and
concentrating the liquid.

11. The process according to claim 2, wherein the incubation is carried out by standing for at least 24 hour.

12. The process according to claim 11, wherein the incubation is carried out by standing for at least 120 hours.

13. The process according to claim 2, wherein the incubation is carried out in the presence of at least five-fold (w/w) water with reference to the fresh tea leaves.

14. The process according to claim 13, wherein the incubation is carried out in the presence of at least seven-fold (w/w) water with reference to the fresh tea leaves.

15. The process according to claim 2, wherein a milling time is from 1 second to 3 minutes.

16. The process according to claim 2, wherein stems of tea leaves are used as the fresh tea leaves.
